(19) United States
(12) Patent Application Publication
(10) Pub. No.: US 2009/0074631 A1
(43) Pub. Date: Mar. 19, 2009

(54) Microwave Chemical Reactor

(75) Inventor: Iginio Longo, Pisa (IT)

Correspondence Address: DENNISON, SCHULTZ & MACDONALD, 1727 KING STREET, SUITE 105, ALEXANDRIA, VA, 22314, US

(73) Assignee: CNR Consiglio Nazionale delle Ricerche, Rome (IT)

(21) Appl. No.: 11/722,723

(22) PCT Filed: Dec. 14, 2005
(86) PCT No.: PCT/IB05/03782

§ 371 Date: Jan. 30, 2008

(30) Foreign Application Priority Data
Dec. 24, 2004 (IT) PI2004A000097

(51) Int. Cl. B01J 19/08

(52) U.S. Cl. 422/186; 422/186

(57) ABSTRACT

Microwave heating apparatus (1) for chemical-physical processes comprising a microwave source (4), for example a magnetron or a klystron or a solid state oscillator (FET transistor), operatively connected to an end of an antenna (10) at a connector (12). The antenna (10) is put in a reaction container (3) where it irradiates with microwaves a reacting material (25). In particular, the antenna (10) can be coated with a sheath (15) that avoids a direct contact with the reacting material (25), or alternatively, can be put into in a housing (7) executed in the container (3). The housing (7), made of a material transparent to microwaves, can cross the reaction container (3) for a part thereof, or for all its width. The arrangement of the antenna (10) in the reacting material (25) provides a quick and effective heating. Furthermore, it is possible to increase considerably the selectivity, the control and the efficiency of a chemical-physical processes to which the heating technique above described is applied. This allows also to provide a considerable energy saving with respect to apparatus of prior art.

### FIELD OF THE INVENTION

The present invention relates to a microwave heating apparatus that can be used as heat source for chemical and/or physical processes.

Furthermore, the invention relates to a method that uses this apparatus for carrying out such processes.

### BACKGROUND OF THE INVENTION

As well known, many chemical processes have to be triggered by high temperature, and other processes are strongly accelerated by high temperature. Therefore, in many cases a reacting material is supplied by energy from a heat source. Traditionally, this is made through apparatus that transfer heat to the reacting material by conductivity or convection. However, such apparatus are often inefficient, since they not perform a uniform distribution of temperature in the reacting material or they require long time for bringing the reaction to a predetermined temperature.

In the last years, microwave apparatus are commonly used in research laboratories and in the industry. In this type of apparatus, a quick variation of the electromagnetic field that influences the material cause its direct heating and with a maximum efficiency with respect to traditional heating methods.

A microwave apparatus typically comprises an oven in which the reacting material is put and then irradiated with radio waves at high frequency. Microwaves are generated by a Magnetron that causes an electronic beam to oscillate at a very high frequency, thus creating microwaves, or more recently they are generated by solid state oscillating devices. These apparatus have relevant advantages with respect to traditional heat source. In fact, they are capable of providing an exceptionally quick heating of the reacting material and of quickly achieving higher temperatures than other conventionally used systems.

However, the technology of heating with microwave ovens has some drawbacks.

Firstly, reactors used for this type of technology have to be made of suitable materials, i.e. materials transparent to microwaves. The used microwave reactors are normally closed in containers with metal walls that are scarcely manageable and are accessible in a difficult way. Furthermore, it is not possible to use microwaves in case of reactions that take place at high pressures, since metal reactors are required with high thicknesses, and for these reactions they cannot be crossed by microwaves.

Other drawbacks are the high cost and the high energy consumption required by the microwave technology that strongly limits its diffusion on a large scale.

### SUMMARY OF THE INVENTION

It is therefore a first feature of the invention to provide a microwave heating apparatus for chemical-physical processes that provides a method for heating a reacting material that is more effective and practical with respect to the devices of prior art.

It is another feature of the invention to provide a microwave heating apparatus for chemical-physical processes that provides an energy saving and that is cheap with respect to apparatus of prior art.

It is also a feature of the invention to provide a microwave heating apparatus for chemical-physical processes for applying the microwave technology also in the field of reactions that take place in a condition of high pressure.

It is also a feature of the invention to provide a microwave heating apparatus for chemical-physical processes for activating chemical reactions in a homogeneous or heterogeneous phase, either continuous or pulsed.

These and other features are accomplished with one exemplary microwave heating apparatus for chemical-physical processes, according to the present invention, said apparatus comprising:
a microwave source,
a reaction container in which a reacting material is arranged,
means for transferring microwaves generated by the source to the reacting material, said means for transferring being arranged directly in the reaction container.

In an exemplary embodiment of the invention, the apparatus comprises also means for emitting one form of energy selected from the group comprised of:
visible waves,
UV waves,
infrared waves,
or a combination thereof.

Advantageously, the reaction container can provide a coating layer made of a heat-insulating material.

In particular, the apparatus can comprise, furthermore, at least one sensor for measuring a process parameter, for example pressure or temperature, during the development of the reaction.

Advantageously, the apparatus comprises also means for mixing the reacting material, for example a mixer of the type with magnetic bar.

Preferably, the means for transferring the microwaves comprises at least one microwave antenna, for example of co-axial type or in a wave guide, which has at an end a connector for being operatively connected to the microwave source, and at the other end a microwave emitter suitable for irradiating the reacting material.

Advantageously, the antenna is coated with a closed sheath of inert material, for example PTFE, glass, ceramics etc., suitable for avoiding a direct contact with the reagents.

In a possible configuration of the invention, the means for transferring the microwaves comprises at least two antennas, which are excited in phase by the source in order to obtain a desired heating configuration. More in detail, the heating configuration is made exploiting the principle of interference of coherent electromagnetic waves emitted by each antenna.

In particular, the end of the antenna at which the transmission of microwaves is performed is of the dipolar type, or monopolar, and has a shape selected from the group comprised of:
a spiral,
coated with dielectric material,
with a radiating slit
with more radiating slits,
with a metal tip.

In particular, the co-axial microwave antenna comprises:
an inner conductor,
a dielectric that coats the inner conductor for all its length,
an outer conductor that covers coaxially the dielectric except from an end portion.

Advantageously, the microwave antenna can furthermore provide:
a choke mounted out of the outer conductor near the end portion, the above described choke comprising a co-axial conductive portion of diameter higher than the outer conductor.

Advantageously, the reaction container has a housing in communication with the outside that crosses it at least for a part thereof. The housing is suitable for receiving, in use, the above described means for transmission.

In particular, the housing is coated with dielectric material transparent to microwaves and prevents from a direct contact of the transmission means with the reacting material.

Advantageously, the reaction container has at least one opening through which it is possible to approach the reacting material for arranging means for measurement, for example of temperature and pressure.

In an exemplary embodiment of the invention, the reaction container comprises:
a reaction chamber having the walls made of material for insulating from the heat flux generated by microwaves,
an external jacket of a metal material of determined thickness capable of resisting to high pressures.

Advantageously, means are provided for modulating the frequency of microwaves to adjust the power transferred to the reacting material responsive to the type of process.

The microwave apparatus, as above described, increases considerably the control, the speed, the selectivity and the stability of the processes. Furthermore, the power emitted by the antenna is adsorbed by the reacting material allowing the operator to work in safety conditions with respect to the emissions of electromagnetic waves. In case of use of high heating power, to avoid residue emissions out of the reaction container, the latter has a shielding layer that is opaque to microwaves, for example, a film, a varnish, or a metal braiding.

According to another aspect of the invention, a method for heating with microwaves a reacting material in chemical-physical processes comprises the steps of:
generating microwaves by a source of power,
irradiating with microwaves the reacting material contained in a reaction container,

whose main feature is that the irradiating step of the reacting material is made through means for transferring the microwaves arranged directly within the reaction container.

### BRIEF DESCRIPTION OF THE DRAWINGS

The invention will now shown with the following description of an exemplary embodiment thereof, exemplifying but not limitative, with reference to the attached drawings wherein:

FIG. 1 shows diagrammatically an elevational front view of a microwave heating apparatus for chemical-physical processes, according to the invention,

FIG. 2 shows diagrammatically an elevational front view of a first exemplary embodiment of a reaction container that can be used in the apparatus of FIG. 1,

FIGS. 5 and 6 show two different exemplary embodiments of microwave antenna that can be used in the apparatus of FIG. 1 in operative conditions,

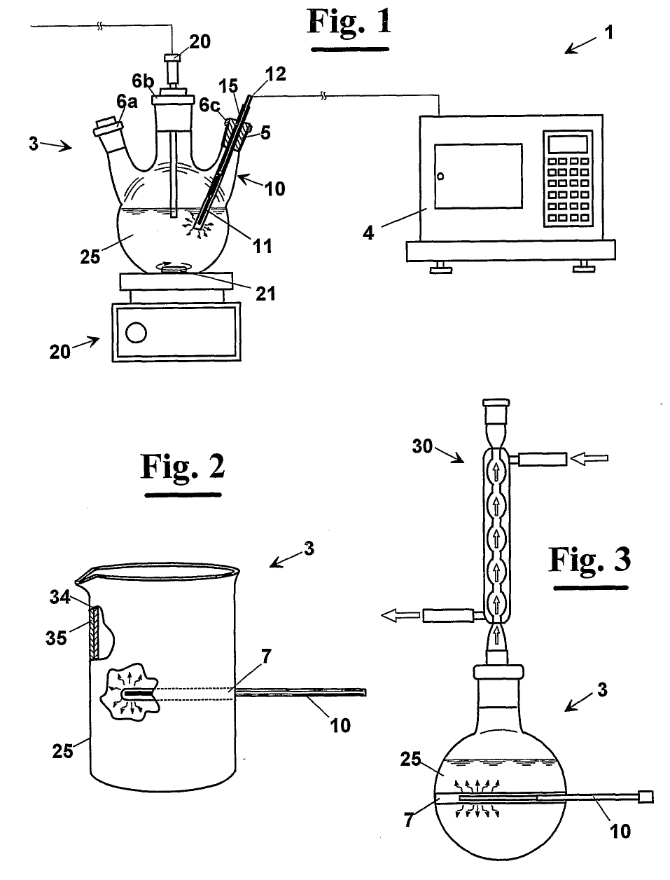

FIGS. from 7A to 7F show diagrammatically elevational side views of some exemplary embodiments of co-axial antennas that can be used in the apparatus of FIG. 1.

### DESCRIPTION OF A PREFERRED EXEMPLARY EMBODIMENT

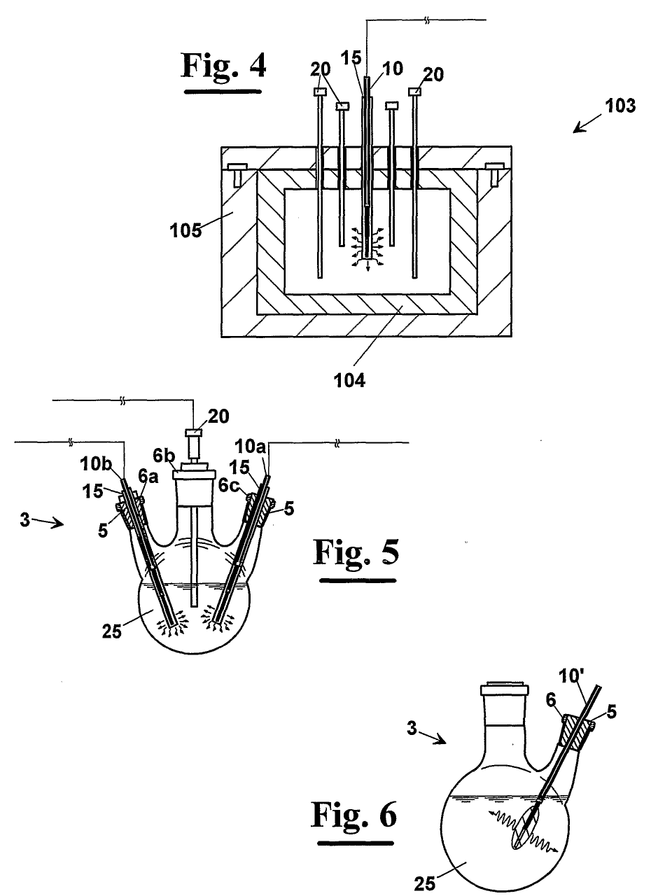

With reference to FIG. 1, a microwave heating apparatus 1 for chemical-physical processes, according to the present invention, comprises a microwave source 4, for example a magnetron or a klystron or a solid state oscillator (FET transistor), operatively connected to an end of an antenna 10 at a connector 12. Antenna 10 is put into a reaction container 3 where it irradiates with microwaves a reacting material 25 at its end 11. In particular, antenna 10 can be coated with a sheath 15 that prevents from a direct contact with the reacting material 25 (FIG. 1), or alternatively, can be put into in a housing 7 made in the container 3. Housing 7, which is made of a material transparent to microwaves, can cross reaction container 3 for a part thereof (FIG. 2), or for all its width (FIG. 3).

The arrangement of antenna 10 in the reacting material 25 provides a quick and effective heating. Furthermore, it is possible to increase considerably the selectivity, the control and the efficiency of the chemical-physical processes to which the heating technique above described is applied. This allows also to provide a considerable energy saving with respect to apparatus of prior art.

Reaction container 3 can be a common container for research laboratories, for example a sphere with three apertures 6a, 6b and 6c (FIG. 1), or alternatively, a beacker (FIG. 2). Reaction container 3 can be of glass or other inert material, which can be coated with a inner layer of PTFE, alumina, or other material resistant at high temperature and pressures.

In case it is necessary to use high power, it is suitable to have reaction container 3 coated with a shielding layer 35, which is next to the external walls 34 of the container 3 (FIG. 2) and opaque to microwaves. This allows to avoid a propagation of microwaves out of the container 3. The shielding layer can be made for example by a film, a varnish, or a metal braiding that reflect microwaves in the reacting material 25.

This allows to an operator to work in safety conditions.

For mixing effectively the reacting material 25, in reaction container 3 a magnetic bar 21 can be put that is wheeled in the reacting material 25 by a mixer 20.

In case of a sphere 3 the apertures 6a, 6b and 6c can be used for arranging sensors 20 that monitor continuously some process parameters, for example the pressure and/or the temperature (FIG. 1). Therefore, the course of the process can be measured instantly and, for example, the frequency and the power of microwaves emitted by antenna 10 can be changed correspondingly.

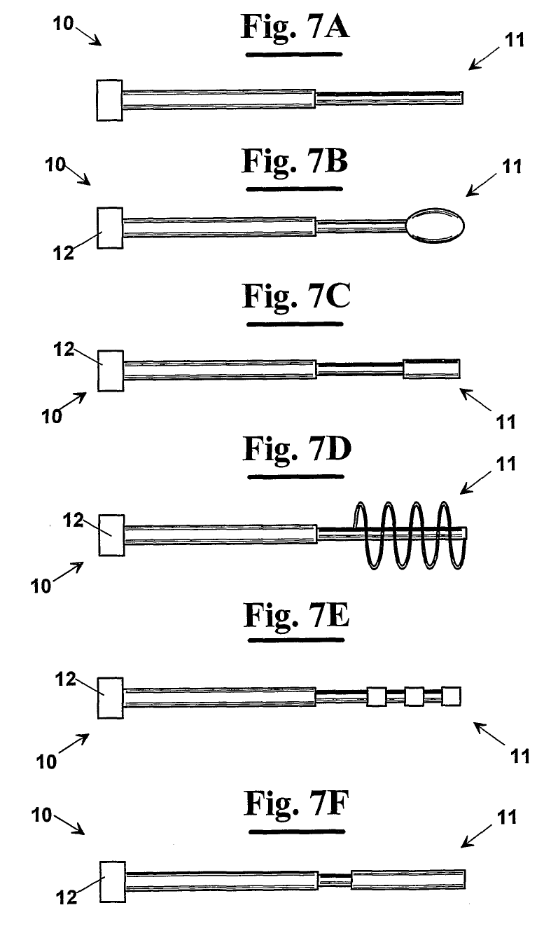

According to an exemplary embodiment of the invention, it is possible to irradiate the reacting material 25 contained in reaction container 3 through a plurality of antennas, for example two antennas 10a and 10b (FIG. 5), which can be excited in phase by the same source. In this way, it is possible to provide a heating configuration with a geometry that is responsive to different operative reasons required by a specific process, exploiting the phenomenon of the interference of coherent electromagnetic waves. The heating apparatus according to the invention is, furthermore, highly flexible and implemented to many types of different processes. For example, in case of reactions exothermic it is possible to associate a reflux coolant of Allhin type 30 (FIG. 3) to a reaction container 3 in which antenna 10 works. In the case, instead, of processes that occur at high pressures a reaction container 103 (FIG. 5) can be provided having a inner jacket 104 of coating thermo-insulating material, for example Teflon, contained in a jacket of a metal material 105 of suitable thickness. In this way it is possible to use the heating technique by means of microwaves for carrying out processes that are performed at high pressures.

In FIG. 6 the possibility is diagrammatically shown of using as heating means an antenna 10′ capable of emitting, in addition to microwaves, visible light waves, UV waves, infrared waves, or a combination thereof, for particular types of processes.

In FIGS. from 7A to 7F some possible exemplary embodiments are shown of an antenna 10 that can be used as microwave emitter. In particular, co-axial antenna 10 can be of dipolar type (FIGS. 7A-7D) and can provide at the microwave emitting end a configuration with a dielectric-tip (FIG. 7A), a sphere tip (FIG. 7B), a metal tip (FIG. 7C), a coil-tip (FIG. 7D), a slotted tip (FIG. 7E), multislotted tip (FIG. 7F). Alternatively, antenna 10 can be of the monopolar type and can be carried out similar to the above described exemplary embodiments. Furthermore, antenna 10 can be provided with a trap or “choke” suitable for preventing the emitted microwaves to spread back towards the source.

The foregoing description of a specific embodiment will so fully reveal the invention according to the conceptual point of view, so that others, by applying current knowledge, will be able to modify and/or adapt for various applications such an embodiment without further research and without parting from the invention, and it is therefore to be understood that such adaptations and modifications will have to be considered as equivalent to the specific embodiment. The means and the materials to realise the different functions described herein could have a different nature without, for this reason, departing from the field of the invention. It is to be understood that the phraseology or terminology employed herein is for the purpose of description and not of limitation.

1. Microwave heating apparatus for chemical-physical processes comprising:
a microwave source,
a reaction container in which a reacting material is arranged,
means for transferring the microwaves generated by the microwave source to said reacting material,
wherein said means for transferring comprises at least one antenna which has at one end thereof a connector which connects the antenna operatively to said microwave source, and at an opposite end thereof a microwave emitter constructed and arranged for irradiating the reacting material,
wherein said antenna is of a coaxial type comprising an inner conductor, a dielectric coating the inner conductor over its length and an outer conductor that coaxially covers the dielectric except over an end portion, and
wherein said means for transferring is arranged directly in said reaction container.

2-16. (canceled)

17. Apparatus according to claim 1 wherein said reaction container is selected from the group consisting of a container providing a coating layer made of heat-insulating material, and a container having a shielding layer opaque to microwaves suitable for avoiding propagation therefrom.

18. Apparatus according to claim 1, additionally comprising means for irradiating the reacting material with one further form of energy selected from the group consisting of visible waves, UV waves, infrared waves, and combinations thereof.

19. Apparatus according to claim 1, additionally comprising at least one sensor for measuring a process parameter during development of the reaction.

20. Apparatus according to claim 1, additionally comprising means for mixing the reacting material.

21. Apparatus, according to claim 1, wherein said antenna is coated with a closed sheath of inert material for avoiding the direct contact with the reacting material.

22. Apparatus according to claim 1, wherein said means for transferring comprises at least two antennas, which are excited in phase from said source in order to obtain a desired heating configuration, by exploiting interference of the coherent electromagnetic waves emitted by each antenna.

23. Apparatus according to claim 1, wherein the end of said antenna at which the transmission of microwaves is performed has is selected from the group consisting of a spiral, coated with dielectric material, having a radiating slit, having a plurality of radiating slits, and having a metal tip.

24. Apparatus according to claim 1, wherein said antenna additionally comprises a choke mounted external to said outer conductor near said end portion, said choke comprising a co-axial conductive portion of diameter greater than said outer conductor.

25. Apparatus, according to claim 1, wherein said reaction container has a housing coated with dielectric material transparent to microwaves suitable for receiving said means for transmission, said housing crossing said container over at least one part thereof.

26. Apparatus, according to claim 1, wherein said reaction container comprises a reaction chamber having the walls made of a material for insulating from heat flux generated by microwaves, and an external jacket of a metal material of predetermined thickness capable of resisting high pressures.
